(19) United States
(12) Patent Application Publication
(10) Pub. No.: US 2005/0022237 A1
(43) Pub. Date: Jan. 27, 2005

(54) Method and system for internet content acquisition according to a program guide

(76) Inventor: Yuji Nomura, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/923,578

(22) Filed: Aug. 20, 2004

Related U.S. Application Data
(63) Continuation of application No. PCT/JP03/01947, filed on Feb. 21, 2003.

(51) Int. Cl. H04N 7/16; G06F 3/00; H04N 5/445

(52) U.S. Cl. 725/39; 725/50

(57) ABSTRACT

Specific requirements for a protocol, which deal with a program guide describing meta-data of content, are described. This protocol enables users and devices to select up-to-date and appropriate content out of a large number of unnecessary content. The protocol allows subscribers (having program guide receivers) to receive updates (from a program guide sender) to either an entire program guide or portion of a program guide, wherein the portion of program guide is defined according to a set of preferences and constraints. Communications between the program guide sender and the program guide receiver are accomplished using a protocol such as a session initiated protocol (SIP).

### CROSS REFERENCE TO RELATED APPLICATION

The present application is a continuation application based on International application No. PCT/JP03/01947, filed on Feb. 21, 2003, which claims priority from U.S. Provisional Application 60/359,036 filed on Feb. 21, 2002.

### BACKGROUND OF THE INVENTION

1. Field of Invention

The present invention relates generally to the field of network-based content acquisition. More specifically, the present invention is related to Internet-based content acquisition using a program guide.

2. Discussion of Prior Art

A program guide provides for a schedule with regard to transmitted content. For example, a program guide associated with cable TV (CATV) systems provide for a schedule of programs (both current programs and future programs), wherein subscribers are able to view such programs to choose one in which they are interested. Additionally, current products such as TiVo® provide users with the ability to manipulate transmitted content. Such products may be similar to a VCR (i.e., they are able to perform the following functions on the transmitted content: record, pause, rewind, and fast forward).

A problem associated with program guides as described in prior art systems is the fact that the airtime associated with the content of a program can dynamically change at airtime. A typical example of this scenario is live content of a sports event. The event's start time may be postponed by weather conditions and its end time may be uncertain. As a result, alternative content may be on the air or the airtime of the subsequent content may be affected. Thus, in such prior art systems, the program guide is not updated to reflect such changes.

Another restrictive aspect of such program guides is that it does not take into account the fact that the resources associated with delivering and storing multimedia content can be restrictive. Multimedia content has different temporal features as resources used to send and receive such content are restrictive. More specifically, as multimedia content requires a large amount of storage capacity (on both the sender's and receiver's end), expensive storage systems may be required. Alternatively, in terms of storage capacity, if the sender (of multimedia content) desires to provide multimedia content requiring a large increase in storage, the sender may continually or periodically provide new content and remove the old content from the system. Therefore subscribers need to have the schedule of availability of the existing content and the changes and availability of the new content on the storage medium.

Also the transmission and reception of such content requires high bandwidth resources on a network (such as the Internet) in addition to the transmission resources of the sender. In many instances, the unavailability of appropriate bandwidth severely limits the ability to receive content. One solution for overcoming the problem associated with the lack of bandwidth is the use of a time-shift access technique, wherein the content is received only upon the availability of appropriate bandwidth. This solution restricts the access time associated with content requiring high-bandwidth. However current systems are inefficient when dynamically allocating or notifying user of the availability of resources or when resources will be available.

Such increases in the size of content, storage limitations, combined with the limitations of bandwidth, causes such content to be unavailable at a specific access time. These content features, by example, can dynamically restrict and change its availability. Users need to receive this information described by the program guide before they access content.

Whatever the precise merits, features, and advantages of the above cited prior art program guides, none of them achieve or fulfills the purposes of the present invention.

[Disclosure of Information on Prior Art Document]

(1) “Session Announcement Protocol”
   by M. Handley
      ACIRI
   C. Perkins
      USC/ISI
   E. Whelan
      UCL
Network Working Group
Request for Comments: 2974
Category: Experimental
October 2000
(2) TiVo®
   <URL: http://www.tivo.com/0.0.asp>

### SUMMARY OF THE INVENTION

The present invention provides for a method and system for receiving an update to a program guide or portion of a program guide from a program guide sender, wherein the portion of program guide is defined according to a set of preferences and constraints. The method, as implemented in a program guide receiver, comprises at least the steps of: (a) transmitting to the program guide sender a subscription request requesting notification of updates associated with the program guide or the portion of program guide; (b) receiving an acknowledgement accepting the subscription request; (c) receiving a notification identifying an update to the program guide or the portion of program guide; (d) identifying from the received notification a location (e.g., a pointer such as a URL) from where to receive the update; (e) receiving the update from the identified location; and (f) building a new program guide based upon the received update. In a particular embodiment, communications between the program guide sender and the program guide receiver are accomplished using a session initiated protocol (SIP).

The program guide comprises one or more programs, each of the programs comprises a set of segments, and the programs or segments comprise source or meta-data information. In a specific embodiment, the meta-data is in an XML format. The source information comprises any of (but should not be limited to) the following: media to which a user has access, channel, URI, file or pathname, frequency, location, audio, video codec, bandwidth, window size, accessible area, or equivalents thereof. The meta-data information comprises any of (but should not be limited to) the following: temporal information, copyright information, distribution policy, validity, title, subtitle, CD or DVD number, musician, drama, show, synopsis, keyword, cast, directors, producers, original airdate, comments, or related URL.

The above system is, in one aspect, a system for receiving multimedia content over a network using a program guide, said program guide being updated dynamically, either in part or in its entirety, at a program guide receiver, said system is operative, by said program guide receiver, to (a) transmit to a program guide sender a request requesting notification of updates associated with either a portion of a program guide or an entire program guide, (b) receive an acknowledgement accepting said request, (c) receive a notification identifying an update to either said portion of a program guide or said entire program guide, (d) identify from said received notification a location from where to receive said update, (e) receive said update from said identified location, (f) build a new program guide based upon said received update, and (g) retrieve said multimedia content using said newly built program guide.

The above system is, in another aspect, a system for receiving multimedia content over a network using a program guide, said system comprising: a program guide receiver for transmitting a request requesting notification of updates associated with either a portion of a program guide or an entire program guide, identifying from a received notification a location from where to receive an update, receiving said update from said identified location, building a new program guide based upon said received update, and retrieving said multimedia content using said newly built program guide; and a program guide sender for transmitting a notification identifying an update to either said portion of program guide or said entire program guide to said program guide in response to said request from said program guide receiver.

In one embodiment, the identified updates are forwarded to an external device (cellular telephone, wireless telephone, pager, personal digital assistant (PDA), set-top box, or mobile computer) associated with a user of the program guide receiver. Communications between the program guide receiver and the external device occurs via any of (but should not be limited to) the following protocols: SIP, POP, SMTP, or HTTP.

In another embodiment, the program guide sender is intermittently available as a part of a network (such as local area network (LAN), wide area network (WAN), or the Internet) and the program guide sender receives the notification during periods when the program guide sender is part of the network.

In yet another embodiment, the program guide receiver stores statistics associated with network traffic during content retrieval/storage to indicate quality of content to a user of the program guide receiver.

### BRIEF DESCRIPTION OF THE DRAWINGS

FIG. 1 illustrates the general functionality associated with the present invention's program guide protocol.

FIG. 2 shows an example of the structure of the program guide of the present invention.

FIG. 3a illustrates a time-line diagram associated with a scenario wherein an update notification is sent by a sender (e.g., a video server/program guide sender) to a user's terminal due to changes in the airtime of a program.

FIG. 3b illustrates a flow chart showing the notification of program guide updates by the sender.

FIG. 3c illustrates a flow chart showing the retrieval of update data via a pointer such as a URL.

FIG. 4 illustrates an example wherein an update to a program guide is sent from a program guide sender to a device that is not a program guide receiver/user's terminal.

FIG. 5a illustrates an example wherein a user's terminal obtains content from an external device such as a camera when it becomes accessible over a network.

FIG. 5b illustrates an equivalent flow chart corresponding to the time-line diagram of FIG. 5a.

FIG. 6 shows the example of a screen image allowing a user to select content according to the quality of received/stored content.

FIG. 7 illustrates an example of content update.

FIG. 8 illustrate another example of content update.

FIG. 9 illustrates an example of a program guide useful in load balancing and efficient capacity utilization.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention's program guide is a set of meta-data describing the features of multimedia content. For example, a non-exhaustive list of meta-data comprises any of the following: uniform resource identifier (URI), airtime, bandwidth, file size, text summary, genre, title, etc. Additionally, the word “content” means multimedia content such as music, video clip, news program, movie, and so on. The phrase “program guide” describes meta-data such as start time, end time, duration, title, channel, frequency, and bandwidth.

It should be noted that the term “device”, as used in this application, applies both to the role of a content sender and a content receiver depending on what role was assigned by the users of such devices. There are two kinds of devices, namely, “receiver” and “sender”. The term “sender” refers to the device that sends the program guide. The term “receiver” refers to the device that receives the program guide. In addition, a device which sends content can be located either in the core or on the edge of a network such as the Internet. Accordingly, the program guide is used by a device which sends or receives content through a network such as the Internet. The receiver can obtain both the program guide and the update notification (similarly, the sender is able to send both the program guide and any update notifications).

Additionally, the present invention takes into account the fact that devices are not always available on a network and its role as a receiver or sender is not stable. Thus, the program guide can be obtained by an alternative, more convenient device for the user. Examples of devices that can communicate via the present invention program guide protocol include, but should not be limited to: cellular phones, PDAs (Personal Digital Assistants), personal computers, streaming video servers, set-top boxes, video cameras, and PVRs (Personal Video Recorders).

Case models of the present invention's program guide generally fall under the following four categories, wherein the categories are classified using: (1) the means of accessing the program guide (automatically or manually) and (2) the means of content retrieval (real-time and time-shift). Table 1, below, shows these models and typical examples.

TABLE 1

| | Manually | Automatically |
|---|---|---|
| Real Time | (1) TV | (3) Live conference broadcasting |
| Time Shift | (2) VCR | (4) Preference-based recording |

Television Model: A human user manually uses the program guide, specifies the content, and watches it in real-time. If the airtime is changed suddenly, and the sender of the program guide notifies the user, the user is able to manually follow the preferred content.

VCR Model: A human user manually uses the program guide, specifies content to be stored, and watches a time-shifted version of the preferred content. If the airtime is changed suddenly, and the sender of the program guide notifies the user, the user can manually specify the preferred content again.

Live Conference Broadcasting Model: A device uses the program guide automatically, specifies content, and shows it to users when it is available. If the availability is changed unexpectedly, and the sender of the program guide notifies the device regarding the change, the device can follow this change automatically.

Preference-Based Recording Model: A device uses the program guide to store content automatically according to a user's direction, such as a preference and configuration. If the availability is changed suddenly, and the sender of the program guide notifies the device regarding the change, the device can follow this change automatically.

The program guide protocol of the present invention supports the request-response message operation, allowing the receiver to obtain the program guide when it is the most convenient to the receiver. For example, in one embodiment, a user may obtain the program guide on demand. Since the program guide may contain a large amount of meta-data, the sender of the program guide does not have to force the data on the user but, rather, waits for a request before delivering the program guide.

In another embodiment, the protocol of the present invention allows for the receiver to obtain a customized program guide. For example, a user may request and receive a subset of the program guide according to his/her preferences and configuration. The preferences may be included in the program guide request message. Otherwise, the protocol may have an individual transaction to send the preferences.

As mentioned earlier, the program guide of the present invention can be updated when its content is changed. The update notification has immediateness and mobility. When a user wants to be notified regarding a change to the program guide (to which the user has subscribed), the sender of the program guide notifies a suitable device (picked based on preferences and configuration) immediately regarding the change. This device may or may not be an original device that has requested the program guide. For example, in the case when a user is away from his/her residence, it is useful to receive the update notification through the user's cellular phone instead of the original device (such as PC or VCR in user's home). Alternatively, if a user is at home, the original device may be preferred. The user may also find it useful to send a notification to multiple devices.

In another scenario, a storage device may require an up-to-date video file that resides on an IP-reachable video camera, but the storage device may find that the camera is not IP-reachable (i.e., it cannot be reached over a network). In this instance, the storage device waits for a notification from the video camera (when it is reachable over a network) indicating the availability of the new video file. Therefore, the content sender notifies a user's terminal of its availability (i.e., when it is reachable over a network such as the Internet) so that the user's terminal can access available content. It should be noted that this mechanism differs from a content push or synchronization as it is the receiver that decides whether or not the content should be obtained. Thus, even if a content sender has not been connected as part of a network for extended periods of time, the sender can notify the update of content upon being part of such a network. This requires a sender initiated notification such as SIP INVITE.

The present invention's program guide protocol provides for reliable message exchange via a reliable transport protocol such as TCP. In the preferred embodiment, the program guide protocol consists of following three stages: 1) program guide request, 2) notification request, and 3) update notification.

Program Guide Request

A receiver sends a request message for a program guide, and, upon reception of such a request, the sender responds with a message containing the program guide. As mentioned earlier, the receiver can also request a customized program guide in the request message. Upon reception of such a request, the sender replies with a message containing the customized program guide (customized according to the request).

Notification Request

A receiver sends the notification request message wherein the message specifies the conditions under which the receiver is to be notified. If a sender receives the notification request message and is able to provide the update that satisfies the request, then the sender replies with an acknowledgement message.

Update Notification

When the sender detects a change in the program guide and if the receiver has requested to be notified of this change, an update notification is sent to the receiver. Upon reception of such an update notification, the receiver replies with an acknowledgement message. As mentioned earlier, this update notification message may be forwarded to a suitable device based on user preferences.

Additionally, it should be noted that the present invention's program guide describes various multimedia content. Meta-data may describe a meta-program guide, which indicates pointers to other senders providing different program guides. Meta-data of content can be represented using various formats. For example, SDPng can describe meta-data of content by using XML. Since it addresses a multiparty multimedia conference, it is necessary to extend the XML schema in order to describe general multimedia content. In another example, MPEG-7 can describe meta-data of content by using XML. It defines XML schema for general multimedia content. It can also describe the program guide structure.

Regarding event notifications and request response message operations, various protocols can be used. For example, Session Initiated Protocol (SIP) and SIP-Specific Event Notification can be used to notify the update of the program guide. SIP-Specific Event Notification enables one to subscribe to a specific program guide and to receive notifications regarding updates. Also, HTTP can be used to request-response message operation for the program guide.

It should be noted that although the above examples use protocols such as SIP and HTTP, other embodiments are envisioned wherein SOAP or XML content load are used to achieve the same functionality. Accordingly, a user who wants to obtain up-to-date content from the server can obtain it in an “instant messaging” manner.

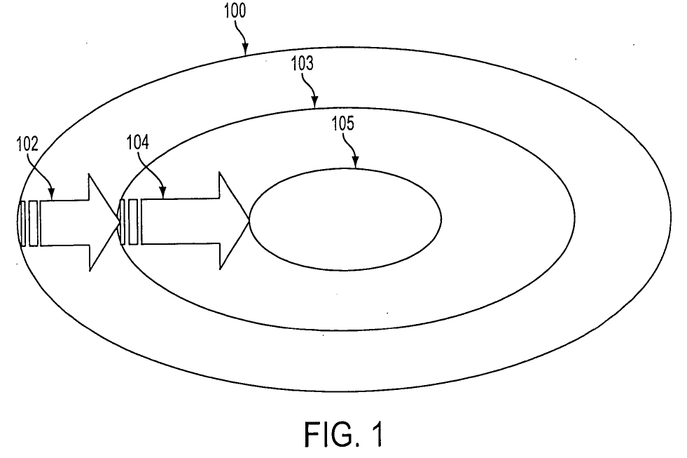

FIG. 1 illustrates the general functionality associated with the program guide protocol. A user can select content 100 on a network such as the Internet according to a set of preferences 102 (thereby reducing content 100 to preferable content 103) and constraints 104 such as a storage capacity, time, and bandwidth (thereby reducing preferable content 103 to storable content 105). Since the program guide describes the availability of content, the user can opt to obtain the content within a given time period. On the other hand, if the user has a specific time that is most convenient for content download, the user can opt to get desired content at that time. For example, the user can decide to receive the content when the user's storage has enough disk space or when the network has enough bandwidth for transfer.

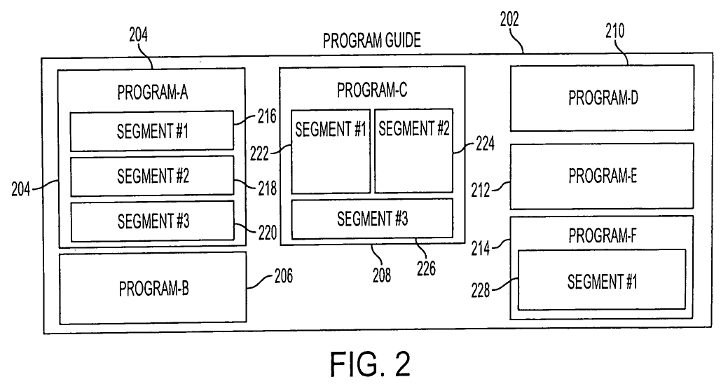

FIG. 2 shows an example of the structure of the program guide. There are two kinds of units to describe the program guide 202: the program section 204, 206, 208, 210, 212, 214 and the segment section 216, 218, 220, 222, 224, 226, 228. The user usually watches a program as a basic unit. Each program section consists of zero or more segment sections. For example, a segment section can include music, news topics, commercial films, etc. It should be noted that segments can be independently watched. Both the program section and the segment section include meta-data. The data that is described in the program section can be omitted in the segment section.

The program or segment sections comprise the following information: source information and meta-data information. Source information includes, but should not be limited to: media to which the user has access, channel, URI, file or pathname, frequency, location, audio, video codec, bandwidth, window size, accessible area, etc. It should be noted that several sources may occur in a program or segment. Meta-data information includes (but should be limited to): temporal information (start time, end time, duration, etc.), copyright information, distribution policy, validity, title, subtitle, CD or DVD number, musician, drama, show, synopsis, keyword, cast, directors, producers, original airdate, comments, related URL, etc.

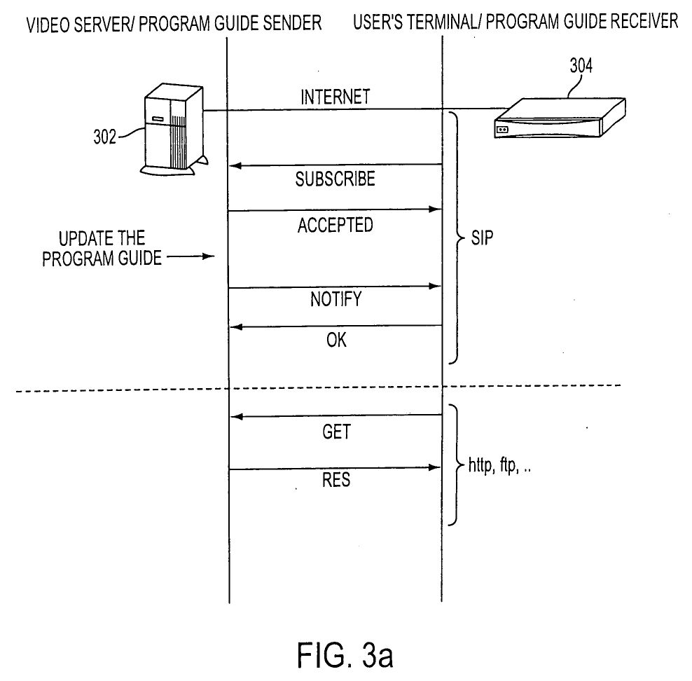

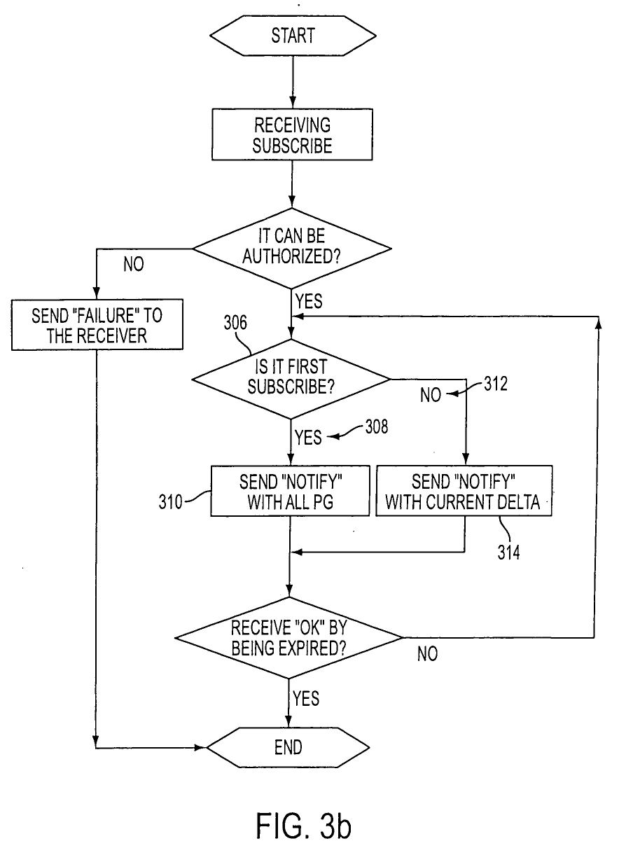

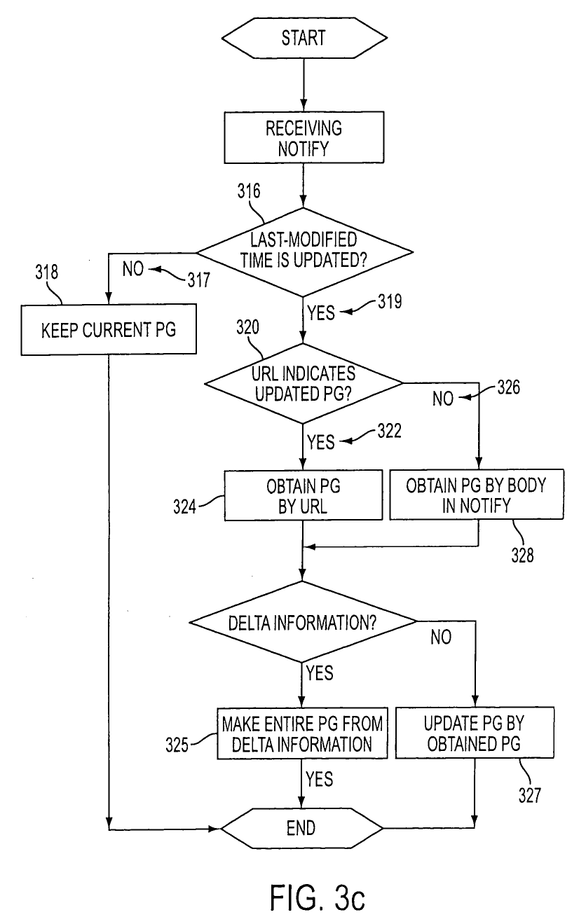

FIG. 3a illustrates a time-line diagram associated with a scenario wherein an update notification is sent by sender 302 (e.g., a video server/program guide sender) to a user's terminal 304 due to changes in the airtime of a program. In this example, the user's terminal (program guide receiver) 304 subscribes (via a SUBSCRIBE message as per the SIP protocol) to receive updates from a sender 302. In SUBSCRIBE message, the user's terminal 304 can include its preference information such as genre, duration, and so on. If the sender 302 accepts this request, it sends an ACCEPT message as per the SIP protocol. If the SUBSCRIBE message includes the user's preference information, the server watches changes in the program guide that match the user's preference (by using the pattern matching mechanism like the word matching).

Subsequently, the sender 302 detects changes and sends a NOTIFY message, as per the SIP protocol. Then, the receiver responds the acknowledgement with an OK message, as per the SIP protocol. The NOTIFY message includes information describing the changes or a pointer, such as URL, indicating the changes. If NOTIFY includes the URL, the receiver uses a protocol such as HTTP or FTP in order to obtain information regarding the program guide changes. After the receiver 304 obtains the program guide, the receiver can get multimedia content that is described by the program guide.

FIGS. 3b-c illustrate an equivalent flow chart corresponding to the time-line diagram of FIG. 3a. FIG. 3b illustrates a flow chart showing the notification of program guide updates by the sender. A check 306 is performed to identify if an authorized request for subscription is a first request, and if so 308, a NOTIFY message is sent with the program guide 310. If the request is not a first request 312, a NOTIFY message is sent with just the program guide data that is changed (i.e., current delta corresponding to the change in program guide) 314.

FIG. 3c illustrates a flow chart showing the retrieval of update data via a pointer such as a URL. A check 316 is performed to see if the last-modified time is updated, and if the time was not updated 317, the current program guide is retained 318. In the instance that the last-modified time is updated 319, another check 320 is performed to see if a pointer, such as an URL, is provided to indicate the location of the update. In the presence of such a pointer 322, the program guide is obtained 324 (i.e., either the change in the program guide is used to create a new program guide 325 or the entire program guide is obtained 327). In the absence of a pointer 326, the program guide is obtained from the Body in the notification message 328, and either the change in the program guide is used to create the new program guide 325 or the entire program guide is obtained 327.

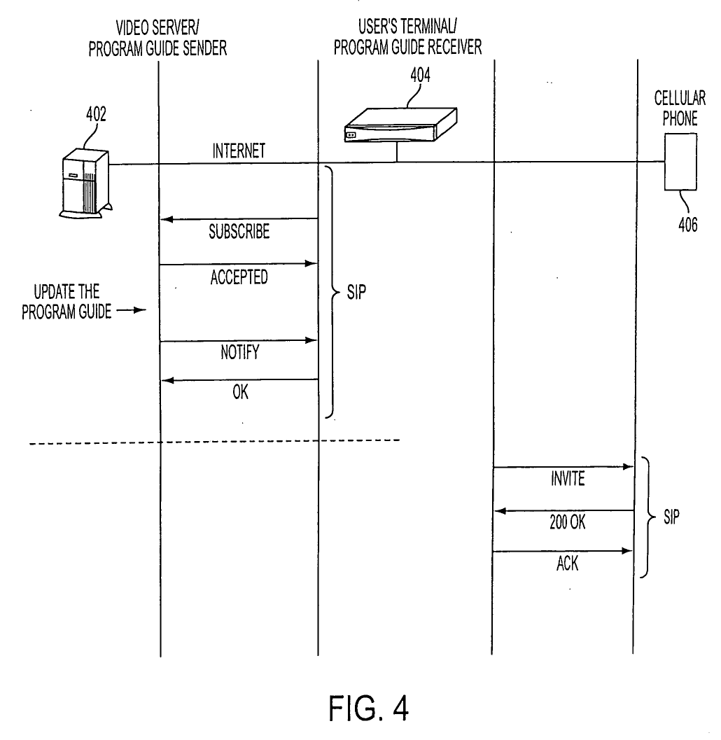

FIG. 4 illustrates an example wherein an update to a program guide is sent from a program guide sender 402 to a device 406 that is not a program guide receiver/user's terminal 404. In this example, the receiver 404 sends an INVITE message to the external device (e.g., cellular phone, pager, PDA, etc.) 406 as per the SIP protocol. The INVITE message includes the changes in the program guide or the pointer, such as URL, indicating the changes. If the INVITE message includes the URL, the external device (such as a cellular phone) 406 is able to access the changes by using a protocol such as HTTP or FTP (like the example mentioned above). The URL provides information in the user's terminal or the video server 404. Thus, a user who wants to obtain an up-to-date program guide can obtain it even when he/she in not near the terminal 404.

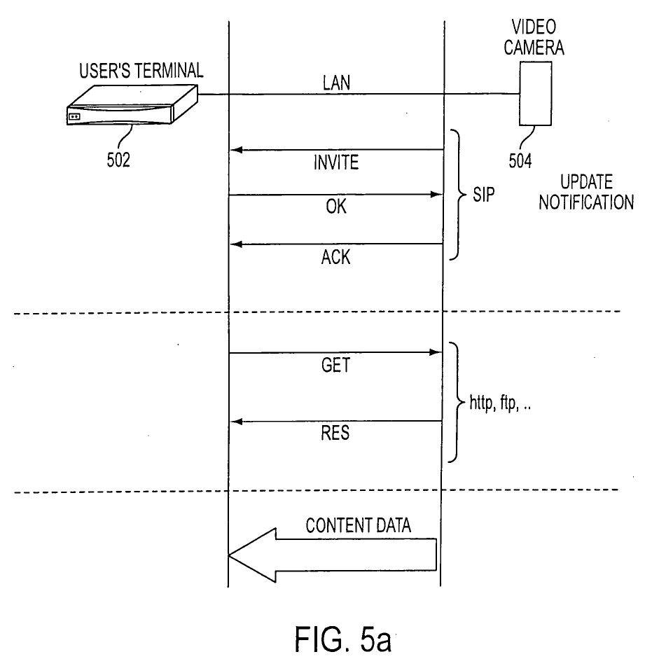

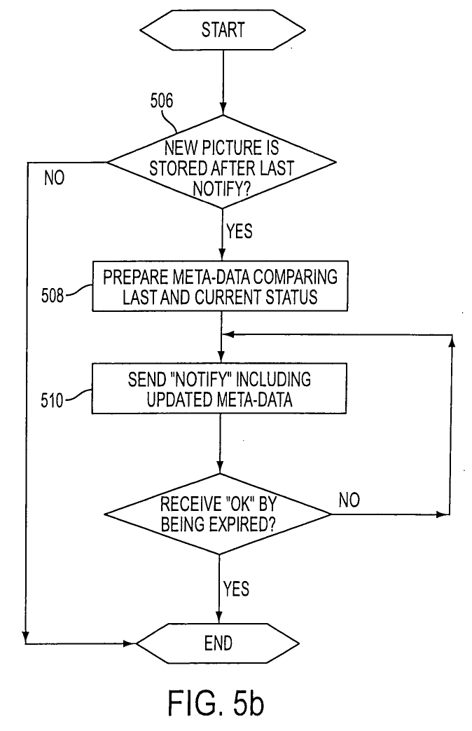

FIG. 5a illustrates an example wherein a user's terminal obtains content from an external device such as a camera 504 when it becomes accessible over a network. Thus, if a user's terminal 502 requires a file that is located on an unrecognizable video camera 504 (i.e., unrecognizable over the network the user's terminal is connected to) that is connected on the same network; the camera notifies the terminal 502 that it is connected on the same network. When resources on the camera are available, first the camera 504 sends an INVITE message, including the URL of the program guide, to the terminal 502. After the terminal 502 sends an ACKNOWLEDGEMENT signal and receives its reply, the terminal 502 gets the program guide given by the URL. Finally, the terminal gets the file according to the program guide. Once the user has obtained the program guide, the user can confirm whether the camera has new content. Thus, a user can obtain up-to-date content on a device that is intermittently connected on a network.

FIG. 5b illustrates an equivalent flow chart corresponding to the time-line diagram of FIG. 5a. A check 506 is performed to see if new content is stored after the last notification, and if so, the meta-data comparing the last and the current status is prepared 508. In step 510, a notification message is sent with the updated meta-data.

Although, in the above examples (and in the following examples) specific protocols such as SIP, HTTP, and FTP are utilized, other equivalent protocols and notification mechanisms can achieve the same functions. For example, the receiver can send an electronic message such as an e-mail to the external device (e.g., cellular phone) by using POP or SMTP. Thus, the type of messaging protocols used should not be used to restrict the scope of the present invention.

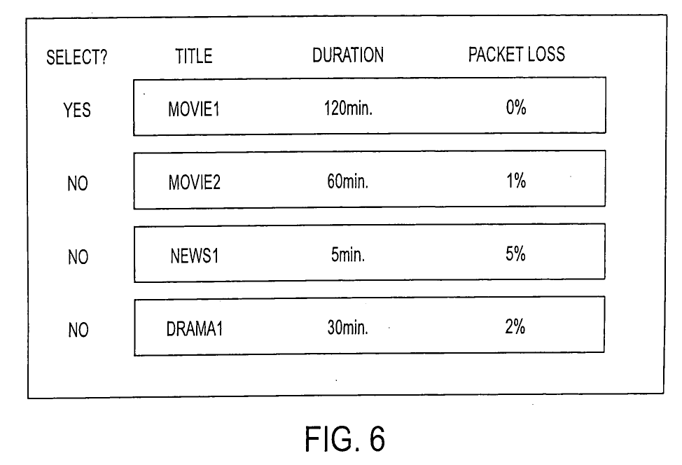

Using the program guide protocol of the present invention, users are able to store content on their storage such as the user's terminal like a VCR. Storing such content enables the user to confirm the quality of content before watching such content. For example, when the storage obtains content on a network such as the Internet, the storage can record statistics describing the quality of the received content, such as packet loss ratio. After recording content, the storage can show the statistics to the user. The user can then decide the quality of content according to the statistics. As the traffic quality of the Internet is usually uncertain when it is obtained, users are able to confirm the quality in real-time. The user is also able to use the program guide and confirm in advance, the content to be stored. FIG. 6 shows the example of a screen image in order to select content according to the quality of received/stored content.

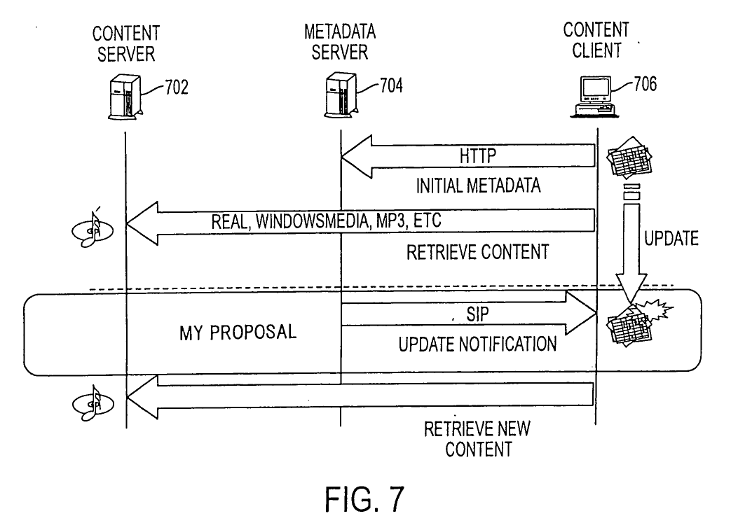

FIG. 7 illustrates a scenario wherein metadata server 704 provides content client 706 with any subscribed updates, and a content server 702 allows for multimedia content retrieval by content client 706. First, the content client 706 requests and retrieves metadata from metadata server 704. Next, the content client 706 retrieves multimedia content from content server 702. It should be noted that a transport mechanism, such as HTTP, can be used to carry metadata. However, using the HTTP protocol for metadata transport is an inefficient refresh mechanism (i.e., inefficient because the refresh mechanism is by polling). The mechanism for refreshing metadata needs to be improved to send frequent HTTP requests, but such frequent requests could increase the load on the host receiving the requests. A solution based upon the present invention is for the metadata server 704 to send an update notification to the content client when metadata changes. Thus, the number of messages needed for updating is less than the number of HTTP refresh messages as required in the above-mentioned scenario. The content client 706 can retrieve content by using any existing content transport mechanism, such as Real Video®, Windows® Media, or HTTP.

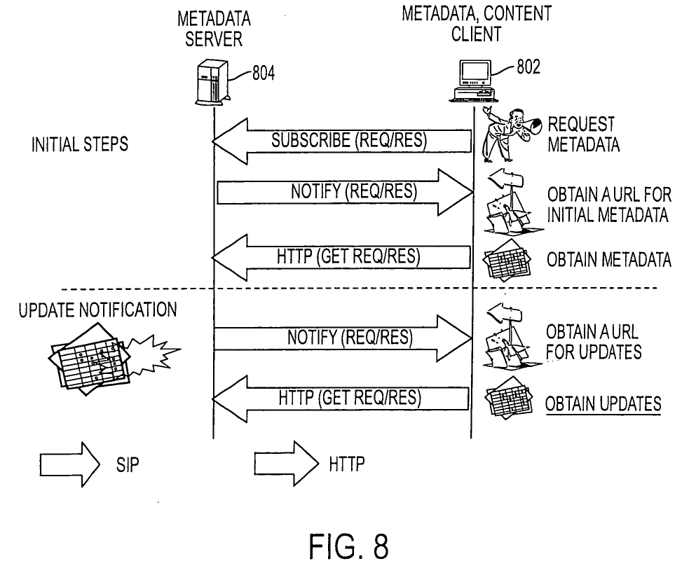

FIG. 8 illustrates the basic protocol operations of the update notification via SIP. First, a metadata/content client 802 sends a SUBSCRIBE request to a metadata server 804 for receiving a subsequent update notification from the metadata server 804. When metadata server 804 authenticates the subscription request, server 804 sends a SUBSCRIBE acknowledgement response and a NOTIFY request to the same client 802. The request contains either the requested metadata or a URL indicating a location of the metadata. When the client 802 receives the request, it tries to obtain metadata specified in the body. When metadata has changed, the server sends a NOTIFY request to the client. The request body contains a URL for metadata or the metadata itself. When the client receives the request, the subscriber tries to obtain metadata specified in the body by the URL. Finally, the client gets the metadata by using HTTP.

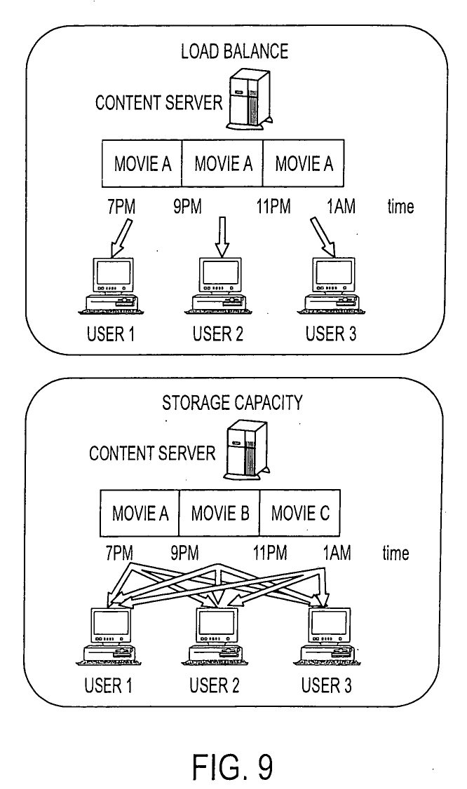

FIG. 9 illustrates an example of a program guide useful in load balancing and efficient capacity utilization. A program guide sender node controls user access times for efficient use of bandwidth and for balancing the load on a network (or on the sender node) in a unicast (a different schedule for each user may be sent in a unicast scenario) or multicast scenario. The number of acceptable sessions on a content distribution network or video server is usually limited due to the lack of bandwidth or network resources (such as server, node or distribution time resources). A solution in such a scenario is to distribute a program guide which is tailored to the individual users. For example, in the load balancing situation there is limited network resources for delivering movie A, therefore movie A is available to user1 at 7 PM, user2 at 9 PM and user3 at 11 PM or 1 AM. It should be noted that the program times can be changed dynamically depending upon the availability of resources. If additional resources become available, for example, user3 may be able to access the movie from 9 PM to 1 AM.

In terms of storage capacity—if the storage capacity resources of the content server are limited, then movie A may be available to the users from 7-9 PM, movie b from 9-11 PM, and movie c from 11 PM to 1 AM. This causes the restriction of the availability times. If the sender nodes desires to increase the number of content offerings provided to end users, it can renew the content on the storage node periodically.

Alternatively, by tracking the status of network resource utilization, the program guide is able to provide limited bandwidth users a scheduled time to assure that they are served across the distributed network. The program guide of the present invention also ensures (by continuous SIPG polling notification in an instant messaging fashion) that such users are not timed-out by bigger, faster pipelines. A SIPG notification could be generated in real-time, on-the-fly, to provide a dynamic customized guide at each client/server node. It is possible to embed a profile of a user within the packet such that a personalized profile is possible to be displayed.

Many current peer-to-peer applications present a decentralized face while relying on a central facilitator to coordinate operations achievable to distribute program guide features. To a user of an instant messaging system, the application appears to be like a peer-to-peer application, sending data directly to a client node being messaged. Yet many instant messaging systems have a server on the back end that facilitates nodes talking to each other. The server maintains an association between the user's name and current IP address, buffers messages in case the user is offline, and routes messages to users behind firewalls. The present invention's system can allow direct client node-to-client node communication when possible but has a server node as a fallback as needed by a user of the program guide systems.

### CONCLUSION

A system and method has been shown in the above embodiments for the effective implementation of a method and system for Internet content acquisition according to a program guide. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by type of messaging protocol, format of meta-data, type of external device capable of communicating via the present invention's program guide protocol, software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of web programming (e.g., HTML, XML, etc).

1. A method for receiving multimedia content over a network using a program guide, said program guide updated dynamically, either in part or in its entirety, at a program guide receiver, said method as implemented in said program guide receiver comprising the steps of:
a. transmitting to a program guide sender a request requesting notification of updates associated with either a portion of a program guide or an entire program guide;
b. receiving an acknowledgement accepting said request;
c. receiving a notification identifying an update to either said portion of program guide or said entire program guide;
d. identifying from said received notification a location from where to receive said update;
e. receiving said update from said identified location;
f. building a new program guide based upon said received update; and
g. retrieving said multimedia content using said newly built program guide.

2. A method as per claim 1, wherein said retrieval of multimedia content using said newly built program guide is based upon preferences and constraints.

3. A method as per claim 1, wherein said multimedia content is retrieved from a content server based upon account load balancing constraints or storage constraints.

4. A method as per claim 1, wherein said notification identifying said update is received via an instant messaging protocol.

5. A method as per claim 1, wherein said identified updates are forwarded to an external device associated with a user of said program guide receiver.

6. A method as per claim 5, wherein communication between said program guide receiver and said external device is via any of the following protocols: SIP, POP, SMTP, or HTTP.

7. A method as claim 5, wherein said external device is any of the following: cellular telephone, wireless telephone, pager, personal digital assistant (PDA), or mobile computer.

8. A method as per claim 1, wherein said program guide sender is intermittently available as a part of said network and said program guide sender receiving said notification during periods when said program guide sender is part of said network.

9. A method as per claim 1, wherein said location where said update is to be received from is a pointer.

10. A method as per claim 9, wherein said pointer is a URL.

11. A method as per claim 1, wherein said network is any of the following: local area network (LAN), wide area network (WAN), or the Internet.

12. A method as per claim 1, wherein communications between said program guide sender and said program guide receiver is via a session initiated protocol (SIP).

13. A method as per claim 1, wherein said program guide comprises one or more programs, each of said programs comprises a set of segments, and said programs or segments comprise source or meta-data information.

14. A method as per claim 13, wherein said meta-data is in an XML format.

15. A method as per claim 13, wherein said source information comprises any of the following: media which a user has access, channel, URI, file or pathname, frequency, location, audio, video codec, bandwidth, window size, or accessible area.

16. A method as per claim 13, wherein said meta-data information comprises any of the following: temporal information, copyright information, distribution policy, validity, title, subtitle, CD or DVD number, musician, drama, show, synopsis, keyword, cast, directors, producers, original airdate, comments, or related URL.

17. A method as per claim 1, wherein said program guide receiver retrieves and stores multimedia content based upon said program guide, and said program guide receiver additionally stores statistics associated with network traffic during said retrieval to indicate quality of content to a user of said program guide receiver.

18. A method for dynamically updating a program guide over a network, said program guide aiding in the retrieval of multimedia content, said method as implemented in a program guide sender comprising the steps of:
a. receiving from a program guide receiver a request requesting notification of updates associated a program guide;
b. transmitting to said program guide receiver an acknowledgement accepting said request;
c. identifying preferences and constraints associated with said program guide receiver;
d. monitoring changes associated with said program guide based upon said identified preferences and constraints;
e. upon detecting a change in said program guide, transmitting a notification identifying an update to said program guide; said notification identifying a URL from where to receive said update,
whereby said program guide receiver receives said notification, retrieves said update from said URL, builds a new program guide based upon said retrieved update, and retrieves multimedia content based upon said newly built program guide.

19. A method as per claim 18, wherein said program guide sender is intermittently available as a part of said network and said program guide sender receiving said notification during periods when said program guide sender is part of said network.

20. A method as per claim 18, wherein said network is any of the following: local area network (LAN), wide area network (WAN), or the Internet.

21. A method as per claim 18, wherein communications between said program guide sender and said program guide receiver is via a session initiated protocol (SIP).

22. A method as per claim 18, wherein said program guide comprises one or more programs, each of said programs comprises a set of segments, and said programs or segments comprise source or meta-data information.

23. A method as per claim 22, wherein said meta-data is in an XML format.

24. A method as per claim 22, wherein said source information comprises any of the following: media which a user has access, channel, URI, file or pathname, frequency, location, audio, video codec, bandwidth, window size, or accessible area.

25. A method as per claim 22, wherein said meta-data information comprises any of the following: temporal information, copyright information, distribution policy, validity, title, subtitle, CD or DVD number, musician, drama, show, synopsis, keyword, cast, directors, producers, original airdate, comments, or related URL.

26. A method for receiving multimedia content from a sender operating intermittently on a network, said reception of multimedia content based upon a program guide updated by said sender, said update performed upon availability of said sender in said network, said method as implemented in a program guide receiver comprising the steps of:
a. receiving an invitation from said sender upon availability in said network, said invitation providing a pointer for an update to said program guide;
b. transmitting an signal acknowledging the reception of said invitation;
c. retrieving said update according to said pointer;
d. building a new program guide based upon said retrieved update; and
e. retrieving multimedia content according to said newly built program guide and during a time-frame when said sender is available as part of said network.

27. A method as per claim 26, wherein said pointer is a URL.

28. A method as per claim 26, wherein said network is any of the following: local area network (LAN), wide area network (WAN), or the Internet.

29. A method as per claim 26, wherein communications between said program guide sender and said program guide receiver is via a session initiated protocol (SIP).

30. A method as per claim 26, wherein said program guide comprises one or more programs, each of said programs comprises a set of segments, and said programs or segments comprise source or meta-data information.

31. A method as per claim 30, wherein said meta-data is in an XML format.

32. A method as per claim 30, wherein said source information comprises any of the following: media which a user has access, channel, URI, file or pathname, frequency, location, audio, video codec, bandwidth, window size, or accessible area.

33. A method as per claim 30, wherein said meta-data information comprises any of the following: temporal information, copyright information, distribution policy, validity, title, subtitle, CD or DVD number, musician, drama, show, synopsis, keyword, cast, directors, producers, original airdate, comments, or related URL.

34. A method for forwarding an update to a program guide or portion of a program guide to an external device associated with user, said user also associated with a program guide receiver, said portion of program guide defined according to a set of preferences and constraints, said update performed over a network, said method as implemented in said program guide receiver comprising the steps of:
a. transmitting to a program guide sender a request requesting notification of updates associated with said program guide or said portion of program guide;
b. receiving an acknowledgement accepting said request;
c. receiving a notification identifying an update to said program guide or said portion of program guide;
d. identifying from said received notification a URL for retrieving said update; and
e. forwarding said URL to said external device of a user associated with said program guide receiver;
wherein said external device either retrieves an updated program guide or builds a new program guide based upon said retrieved update associated with said portion of program guide and said external device uses said program guide to retrieve multimedia content.

35. A method as per claim 34, wherein said network is any of the following: local area network (LAN), wide area network (WAN), or the Internet.

36. A method as per claim 34, wherein communications between said program guide sender and said program guide receiver is via a session initiated protocol (SIP).

37. A method as per claim 34, wherein said program guide comprises one or more programs, each of said programs comprises a set of segments, and said programs or segments comprise source or meta-data information.

38. A method as per claim 37, wherein said meta-data is in an XML format.

39. A method as per claim 37, wherein said source information comprises any of the following: media which a user has access, channel, URI, file or pathname, frequency, location, audio, video codec, bandwidth, window size, or accessible area.

40. A method as per claim 37, wherein said meta-data information comprises any of the following: temporal information, copyright information, distribution policy, validity, title, subtitle, CD or DVD number, musician, drama, show, synopsis, keyword, cast, directors, producers, original airdate, comments, or related URL.

41. A method as per claim 34, wherein said notification identifying said update is received via an instant messaging protocol.

42. A system for receiving multimedia content over a network using a program guide, said program guide being updated dynamically, either in part or in its entirety, at a program guide receiver, said system is operative, by said program guide receiver, to (a) transmit to a program guide sender a request requesting notification of updates associated with either a portion of a program guide or an entire program guide, (b) receive an acknowledgement accepting said request, (c) receive a notification identifying an update to either said portion of a program guide or said entire program guide, (d) identify from said received notification a location from where to receive said update, (e) receive said update from said identified location, (f) build a new program guide based upon said received update, and (g) retrieve said multimedia content using said newly built program guide.

43. A system as per claim 42, wherein said identified updates at the above (c) are forwarded to an external device associated with a user of said program guide receiver.

44. A system as per claim 43, wherein communication between said program guide receiver and said external device is via any of the following protocols: SIP, POP, SMTP, or HTTP.

45. A system as claim 43, wherein said external device is any of the following: cellular telephone, wireless telephone, pager, personal digital assistant (PDA), or mobile computer.

46. A system as per claim 42, wherein said program guide receiver retrieves and stores multimedia content based upon said program guide, and said program guide receiver additionally stores statistics associated with network traffic during said retrieval to indicate quality of content to a user of said program guide receiver.

47. A system for receiving multimedia content over a network using a program guide, said system comprising:
a program guide receiver for transmitting a request requesting notification of updates associated with either a portion of a program guide or an entire program guide, identifying from a received notification a location from where to receive an update, receiving said update from said identified location, building a new program guide based upon said received update, and retrieving said multimedia content using said newly built program guide; and
a program guide sender for transmitting a notification identifying an update to either said portion of program guide or said entire program guide to said program guide in response to said request from said program guide receiver.

48. A system as per claim 47, wherein said multimedia content is retrieved from a content server based upon account load balancing constraints or storage constraints.

49. A system as per claim 47, wherein said notification identifying said update is received via an instant messaging protocol.

50. A system as per claim 47, wherein said identified updates are forwarded to an external device associated with a user of said program guide receiver.
